(19) United States
(12) Patent Application Publication
(10) Pub. No.: US 2014/0358426 A1
(43) Pub. Date: Dec. 4, 2014

(54) MOBILE TERMINAL AND OPERATING METHOD THEREOF

(71) Applicant: HYUNDAI MOBIS Co., Ltd., Yongin-si (KR)

(72) Inventor: Bum Jo KIM, Hwaseong-si (KR)

(73) Assignee: HYUNDAI MOBIS Co., Ltd., Yongin-si (KR)

(21) Appl. No.: 14/208,253

(22) Filed: Mar. 13, 2014

(30) Foreign Application Priority Data
May 30, 2013 (KR) 10-2013-0061551

(51) Int. Cl. G01C 21/00

(52) U.S. Cl. CPC G01C 21/00; G01C 21/005
USPC 701/446; 701/469; 701/475

(57) ABSTRACT

Provided is a mobile terminal. The mobile terminal includes a receiving unit configured to receive GPS information from a GPS satellite, an acquisition unit configured to acquire sensing information from at least one of a speed sensor and a steering sensor of a vehicle connected through an external interface, a determination unit configured to determine whether the vehicle is positioned within at least one of a shadow area and a multi-path area using at least one of the GPS information and the sensing information, and a calculation unit configured to correct a current position coordinate value of the vehicle calculated from the GPS information using the sense information when the vehicle is determined to be positioned within the at least one area.

### CROSS-REFERENCE TO RELATED APPLICATIONS

This application claims priority under 35 U.S.C. §119 to Korean Patent Application No. 10-2013-0061551, filed on May 30, 2013, the disclosure of which is incorporated herein by reference in its entirety.

### TECHNICAL FIELD

The present invention relates to a mobile terminal, and more particularly, to a mobile terminal having a function of correcting a position error.

### BACKGROUND

In general, GPS modules receive satellite signals transmitted from GPS satellites through GPS receivers to extract position information. Navigation systems that are widely used in vehicles check position information about a vehicle using a GPS module, match the position information into a previously stored digital map, and display a current position of the vehicle on a display device. Navigation systems are adopted and used in a car navigation system, a telematics system, a vehicle audio/video device, and so on. Recently, with the advance in the wireless mobile communication technology, navigation systems may be utilized with an application on a smartphone.

In GPS shadow areas, such as a build jungle, a tunnel, and a structure, since it is difficult to detect a position of a vehicle using only satellite signals transmitted from GPS satellites, the position of the vehicle is estimated using gyro sensors. To accurately estimate a position, gyro sensors should be fixed at one position of a vehicle to sense a rotation angle of the vehicle. Accordingly, when navigation systems are used with a mobile terminal, the mobile terminal should be fixed to a car mount holder.

However, when a driver executes another operation (for example, phone call, message check, etc.) in the mobile terminal, the driver may feel inconvenient in operating the mobile terminal that is fixed to the car mount holder. Also, when a driver picks up the mobile terminal in the hand to execute another operation, the position of the mobile terminal is changed. In this case, it is difficult to expect an accurate sensing result from the gyro sensor.

### SUMMARY

Accordingly, the present invention provides a technical solution for using a navigation system with the mobile terminal being not fixed.

In one general aspect, a mobile terminal includes a receiving unit configured to receive GPS information from a GPS satellite, an acquisition unit configured to acquire sensing information from at least one of a speed sensor and a steering sensor of a vehicle connected through an external interface, a determination unit configured to determine whether the vehicle is positioned within at least one of a shadow area and a multi-path area using at least one of the GPS information and the sensing information, and a calculation unit configured to correct a current position coordinate value of the vehicle calculated from the GPS information using the sense information when the vehicle is determined to be positioned within the at least one area.

The determination unit may determine whether the vehicle is positioned within the shadow area using Dilution of Precision (DOP) information included in the GPS information and specifically, determine that the vehicle is positioned within the shadow area when Positioning DOP (PDOP) is equal to or greater than a first threshold value and Horizontal DOP (HDOP) is equal to or greater than a second threshold value, where the PDOP and the HDOP are included in the DOP information.

The determination unit may determine whether the vehicle is positioned within the multi-path area, using an error between positions of the vehicle which are calculated using the GPS information and the sense information, respectively, and specifically, determine that the vehicle is positioned within the multi-path area when an error between a position of the vehicle calculated using the GPS information and a position of the vehicle calculated using the sensing information is equal to or greater than a certain value for each road grade.

The mobile terminal may further include a matching unit configured to match as a current position of the vehicle the corrected current position coordinate value of the vehicle to map data previously stored in the mobile terminal.

In another general aspect, a method of correcting, by a mobile terminal, a position error of a vehicle includes: receiving GPS information from a GPS satellite, acquiring sensing information from at least one of a speed sensor and a steering sensor of a vehicle connected through an external interface, determining whether the vehicle is positioned within at least one of a shadow area and a multi-path area using at least one of the GPS information and the sensing information, correcting a current position coordinate value of the vehicle calculated from the GPS information using the sense information when the vehicle is determined to be positioned within the at least one area, and matching as a current position of the vehicle the corrected current position coordinate value of the vehicle to map data previously stored in the mobile terminal.

The determining may include determining whether the vehicle is positioned within the shadow area using Dilution of Precision (DOP) information included in the GPS information and specifically, determining that the vehicle is positioned within the shadow area when Positioning DOP (PDOP) is equal to or greater than a first threshold value and Horizontal DOP (HDOP) is equal to or greater than a second threshold value, where the PDOP and the HDOP are included in the DOP information.

The determining may include determining whether the vehicle is positioned within the multi-path area, using an error between positions of the vehicle which are calculated using the GPS information and the sense information, respectively, and specifically, determining that the vehicle is positioned within the multi-path area when an error between a position of the vehicle calculated using the GPS information and a position of the vehicle calculated using the sensing information is equal to or greater than a certain value for each road grade.

Other features and aspects will be apparent from the following detailed description, the drawings, and the claims.

### BRIEF DESCRIPTION OF THE DRAWINGS

FIG. 1 is a block diagram showing a mobile terminal having a function of correcting a position error according to an embodiment of the present invention.

FIGS. 2A and 2B are views illustrating errors caused when only GPS information is used.

FIG. 3 is a flowchart illustrating a method of correcting, by a mobile terminal, a position error according to an embodiment of the present invention.

FIG. 4 is a block diagram illustrating a computer system for the mobile terminal.

### DETAILED DESCRIPTION OF EMBODIMENTS

The above and other aspects of the present invention will be more apparent through exemplary embodiments described with reference to the accompanying drawings. Hereinafter, the present invention will be described in detail through the embodiments of the present invention so that those skilled in the art can easily understand and implement the present invention.

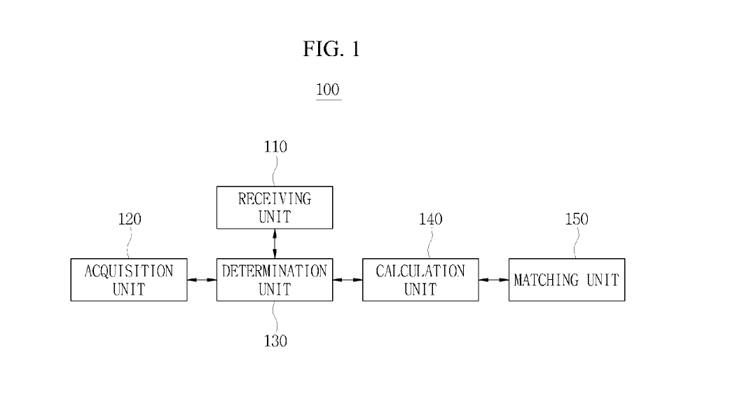

FIG. 1 is a block diagram showing a mobile terminal having a function of correcting a position error according to an embodiment of the present invention.

As shown in FIG. 1, a mobile terminal 100 includes a receiving unit 110, an acquisition unit 120, a determination unit 130, a calculation unit 140, and a matching unit 150. Here, the components of the mobile terminal 100 may be implemented in a Map Matching (MMG) module of a navigation device in the mobile terminal 100.

The receiving unit may be a Global Positioning System (GPS) module, which receives GPS information from a GPS satellite. The received GPS information includes position coordinate information and Dilution of Precision (DOP) information of a vehicle. Here, the DOP information is a value indicating an error that affects positioning according to navigation satellite geometry. If the DOP value is small, an error in the GPS information is also small. The DOP information includes Positioning DOP (PDOP) and Horizontal DOP (HDOP).

The acquisition unit 120 acquires sensing information from a vehicle that is connected through an external interface. Here, the external interface may include at least one of Universal Serial Bus (USB), Bluetooth, and Wi-Fi.

Specifically, the acquisition unit 120 acquires the sensing information from at least one of a speed sensor and a steering sensor of the vehicle. For example, the acquisition unit 120 acquires at least one of speed sensing information and steering sensing information from a converter (for example, AVN, audio equipment, or electronic control unit (ECU)) of a vehicle which is connected with at least one of the speed sensor and the steering sensor of the vehicle. Here, information may be communicated between the speed sensor and steering sensor of the vehicle and the converter through controller area network (CAN) communication and local interconnection network (LIN) communication.

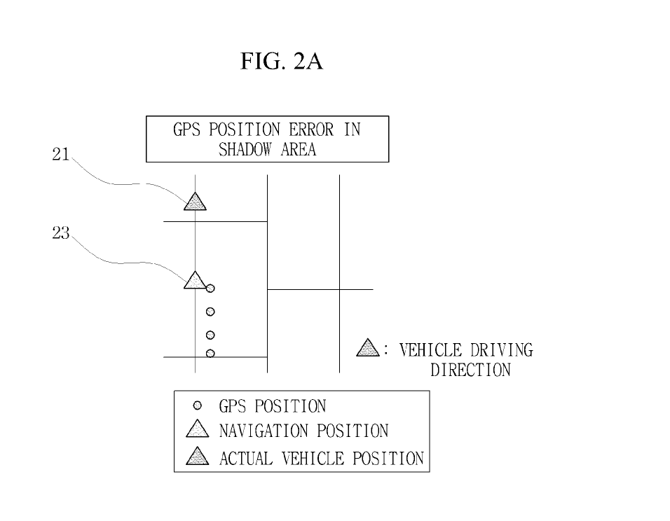

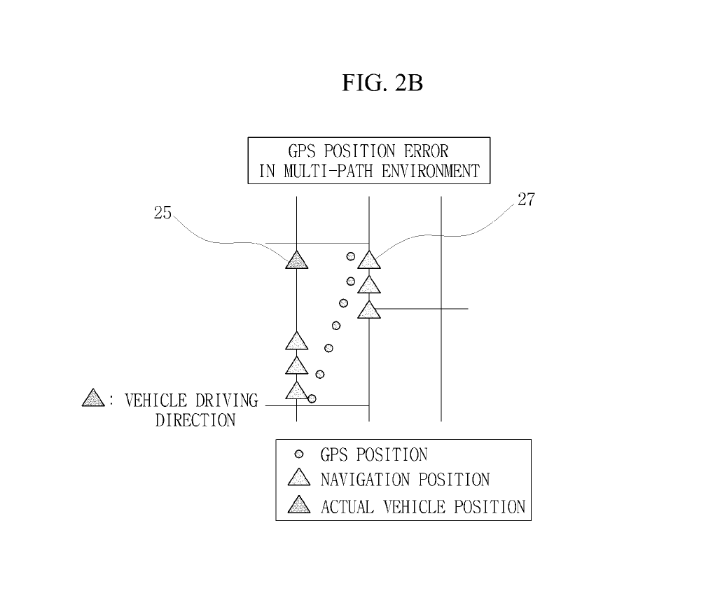

The determination unit 130 determines whether the vehicle is positioned within at least one of a shadow area and a multi-path area. Here, as shown in FIG. 2a, the shadow area is an area where the vehicle is actually positioned on the first point 21 but is determined to be positioned on the second point 23 because reception of the GPS information from the GPS satellite is poor. In addition, as shown in FIG. 2b, the multi-path area is an area where the vehicle is actually positioned on the third point 25 but is determined to be positioned on the fourth point 27 because the GPS information is reflected from a nearby obstruction such as a large building. The determination unit 130 determines an area where the vehicle is positioned, using at least one of the GPS information received through the receiving unit 110 and the sensing information acquired through the acquisition unit 120.

As an example, the determination unit 130 determines whether the vehicle is positioned within the shadow area, using the DOP information included in the GPS information. Specifically, the determination unit 130 determines whether the vehicle is positioned within a shadow area, using PDOP and HDOP of the DOP information included in the GPS information. For example, the determination unit 130 determines that the vehicle is positioned within the shadow area if the PDOP is equal to or greater than a first threshold value and the HDOP is equal to or greater a second threshold value. Here, the first threshold value and the second threshold value are predetermined values. For example, the first threshold value is 50 meters, and the second threshold value is 60 meters. These threshold values may include the number of received satellites and a signal-to-noise ratio (SNR) value.

As another example, the determination unit 130 determines whether the vehicle is positioned within the multi-path area, using an error between positions of the vehicle which are calculated using the GPS information and the sensing information, respectively. Specifically, the determination unit 130 calculates a position (moving distance and rotation angle; (CurPos, xy)) of the vehicle, using the position coordinate information of the vehicle which is included in the GPS information received at certain intervals (e.g. every second). In addition, the determination unit 130 calculates a position (moving distance and rotation angle; (setCargapPos, xy)) of the vehicle, using the sensing information (speed sensing information and steering sensing information) received at certain intervals (e.g. every second). The determination unit 130 determines that the vehicle is positioned within the multi-path area if an error between the position (CurPos, xy) calculated using the GPS information and the position (setCargapPos, xy) calculated using the sensing information is equal to or greater than a certain value. Here, the certain value is a predetermined value depending on a grade of a road. For example, the certain value may be 60 meters if the vehicle is positioned on an expressway and the certain value may be 30 meters if the vehicle is positioned on a general road such as a national highway.

The calculation unit 140 corrects the current position coordinate value of the vehicle calculated from the GPS information using the sensing information. Specifically, if the vehicle is determined by the determination unit 130 to be positioned within at least one of the shadow area and the multi-path area, the calculation unit 140 corrects the current position coordinate value (CurPos) of the vehicle calculated from the GPS information using the sensing information (CargapPos) to calculate a corrected current position coordinate value (CurPos) of the vehicle (that is, CurPos=CurPos+CargapPos).

The matching unit 150 matches the corrected current position coordinate value of the vehicle, which is obtained through the correction by the calculation unit 140, to a current position (MMGPos, xy) of the vehicle. If the vehicle is determined by the determination unit 130 not to be positioned within the shadow area and the multi-path area, the matching unit 150 matches the current position coordinate value calculated using the GPS information to the current position. For example, using the matched current position of the vehicle, the matching unit 150 may display the current position of the vehicle on a map image, which may be used in route searching and route guidance.

As such, according to an embodiment of the present invention, the mobile terminal can accurately position a vehicle even in an area where inaccurate GPS signals are received, such as a GPS signal shadow area or multi-path area by correcting a position coordinate of the vehicle using speed and steering information about the vehicle in addition to GPS information. Also, the mobile terminal does not use the gyro sensor and thus need not be fixed.

In addition, a navigation system may be implemented in an external device, such as a mobile terminal (for example, smartphone), which can be carried by a user. Thus a gyro sensor or GPS module can be removed from a vehicle AVN (Audio Video Navigation) system, thereby reducing components and saving production cost.

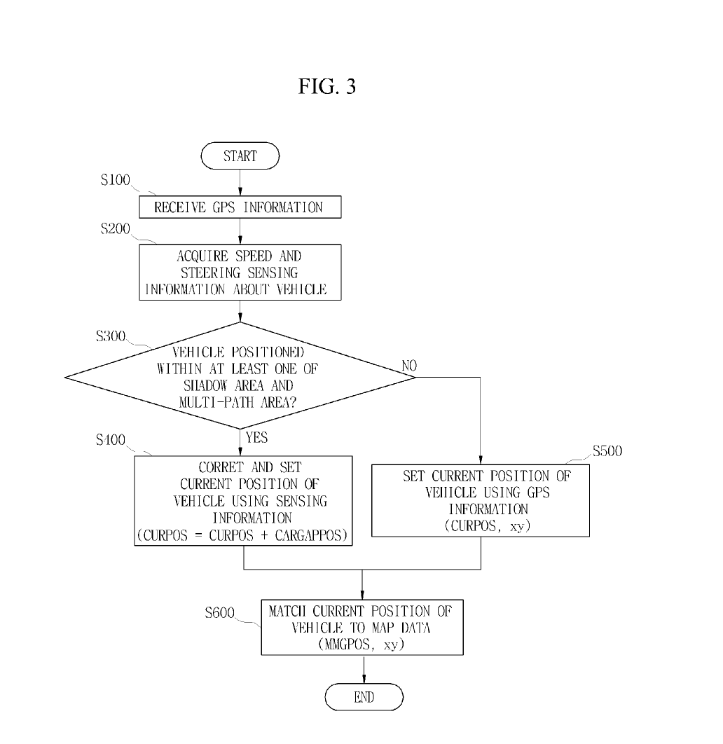

FIG. 3 is a flowchart illustrating a method of correcting, by a mobile terminal, a position error of a vehicle according to an embodiment of the present invention.

In operation S100, the mobile terminal 100 receives GPS information from a GPS satellite.

Here, the GPS information includes position coordinate information and Dilution of Precision (DOP) information of a vehicle. Here, the DOP information is a value indicating an error that affects positioning according to navigation satellite geometry. If the DOP value is small, an error in the GPS information is also small. The DOP information includes Positioning DOP (PDOP) and Horizontal DOP (HDOP).

In operation S200, the mobile terminal 100 acquires sensing information form a vehicle connected through an external interface.

Specifically, the mobile terminal 100 acquires the sensing information from at least one of a speed sensor and a steering sensor of the vehicle. Here, the external interface may include at least one of Universal Serial Bus (USB), Bluetooth, and Wi-Fi. For example, the mobile terminal 100 acquires at least one of speed sensing information and steering sensing information through the external interface from a converter (for example, AVN, audio equipment, or electronic control unit (ECU)) of a vehicle which is connected with at least one of the speed sensor and the steering sensor of the vehicle.

In operation S300, the mobile terminal 100 determines whether the vehicle is positioned within at least one of a shadow area and a multi-path area.

Specifically, the mobile terminal 100 determines an area where the vehicle is positioned, using at least one of the GPS information and the sensing information.

As an example, the mobile terminal 100 determines whether the vehicle is positioned within a shadow area, using the DOP information included in the GPS information. Specifically, the mobile terminal 100 determines whether the vehicle is positioned within the shadow area, using PDOP and HDOP of the DOP information included in the GPS information. For example, the mobile terminal 100 determines that the vehicle is positioned within a shadow area if the PDOP is equal to or greater than a first threshold value and the HDOP is equal to or greater a second threshold value. Here, the first and second threshold values are predetermined values, for example, 50 meters, and 60 meters, respectively. These threshold values may include the number of received satellites and an SNR value.

As another example, the mobile terminal 100 determines whether the vehicle is positioned within the multi-path area, using an error between positions of the vehicle which are calculated using the GPS information and the sensing information, respectively. Specifically, the mobile terminal 100 calculates a position (moving distance and rotation angle; (CurPos, xy)) of the vehicle, using the position coordinate information of the vehicle which is included in the GPS information received at certain intervals (e.g. every second). In addition, the mobile terminal 100 calculates a position (moving distance and rotation angle; (setCargapPos, xy)) of the vehicle, using the sensing information (speed sensing information and steering sensing information) received at certain intervals (e.g. every second). The mobile terminal 100 determines that the vehicle is positioned within a multi-path area if an error between the position (CurPos, xy) calculated using the GPS information and the position (setCargapPos, xy) calculated using the sensing information is equal to or greater than a certain value. Here, the certain value is a predetermined value depending on a grade of a road. For example, the certain value may be 60 meters if the vehicle is positioned on an expressway and the certain value may be 30 meters if the vehicle is positioned on a general road such as a national highway.

As a determination result of operation S300, if the vehicle is determined to be positioned within at least one of the shadow area and the multi-path area, the mobile terminal 100 corrects the current position coordinate value calculated from the GPS information in operation S400.

Specifically, the mobile terminal 100 corrects a current position coordinate value (CurPos) of the vehicle calculated from the GPS information using the sensing information (CargapPos) to calculate a corrected current position coordinate value (CurPos) of the vehicle (that is, CurPos=CurPos+CargapPos).

As a determination result of operation S300, if the vehicle is determined not to be positioned within the shadow area and the multi-path area, the mobile terminal 100 sets the current position coordinate value calculated of the vehicle using the GPS information to the current position of the vehicle in operation S500.

In operation S600, the mobile terminal 100 determines the position of the vehicle which is set at least one of operations S400 and S500 to previously stored map data.

As an example, when the vehicle is determined to be positioned within at least one of the shadow area and the multi-path area, and the current position coordinate value of the vehicle is corrected in operation S300, the mobile terminal 100 sets the corrected current position coordinate value to a current position of the vehicle and matches the current position to previously stored map data.

As another example, if the vehicle is determined not to be positioned within the shadow area and the multi-path area in operation S300, the mobile terminal 100 sets the current position coordinate value calculated using the GPS information to a current position and matches the current position to the previously stored map data.

Using the matched current position of the vehicle, the mobile terminal 100 may display the current position of the vehicle on a map image, which may be used in route searching and route guidance.

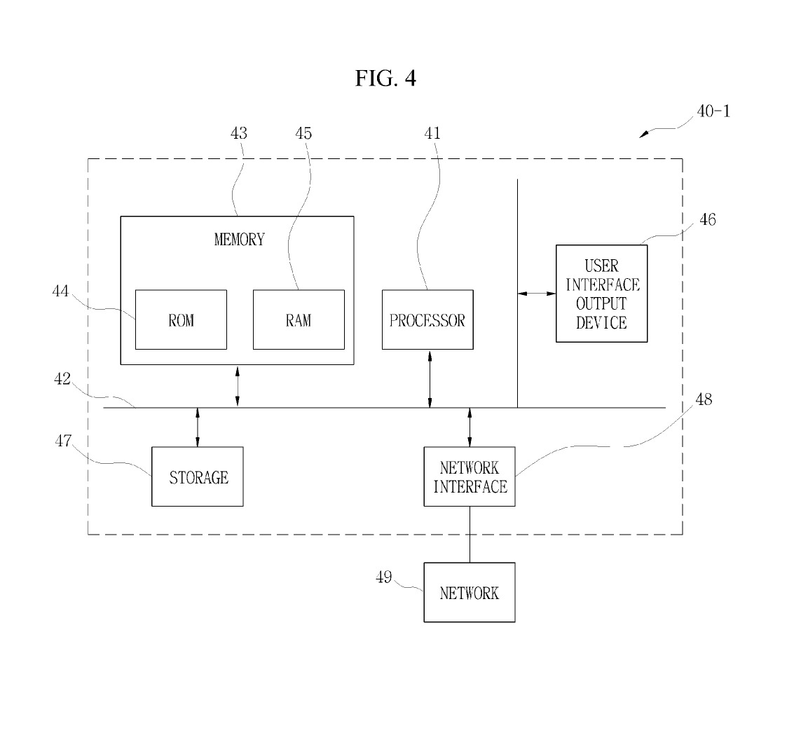

An embodiment of the present invention may be implemented in a computer system, e.g., as a computer readable medium. As shown in FIG. 4, a computer system 40-1 may include one or more of a processor 41, a memory 43, a user output device 46, and a storage 47, each of which communicates through a bus 42. The computer system 40-1 may also include a network interface 48 that is coupled to a network 49. The processor 41 may be a central processing unit (CPU) or a semiconductor device that executes processing instructions stored in the memory 43 and/or the storage 47. The memory 43 and the storage 47 may include various forms of volatile or non-volatile storage media. For example, the memory may include a read-only memory (ROM) 44 and a random access memory (RAM) 45.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

As such, according to an embodiment of the present invention, the mobile terminal can accurately position a vehicle even in an area where inaccurate GPS signals are received, such as a GPS signal shadow area or multi-path area by correcting a position coordinate of the vehicle using speed and steering information about the vehicle in addition to GPS information. Also, the mobile terminal does not use the gyro sensor and thus need not be fixed.

In addition, a navigation system may be implemented in an external device, such as a mobile terminal (for example, smartphone), which can be carried by a user. Thus a gyro sensor or GPS module can be removed from a vehicle AVN (Audio Video Navigation) system, thereby reducing components and saving production cost.

This invention has been particularly shown and described with reference to preferred embodiments thereof. It will be understood by those skilled in the art that various changes in form and details may be made therein without departing from the spirit and scope of the invention as defined by the appended claims. Accordingly, the referred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A mobile terminal comprising:
a receiving unit configured to receive GPS information from a GPS satellite;
an acquisition unit configured to acquire sensing information from at least one of a speed sensor and a steering sensor of a vehicle connected through an external interface;
a determination unit configured to determine whether the vehicle is positioned within at least one of a shadow area and a multi-path area using at least one of the GPS information and the sensing information; and
a calculation unit configured to correct a current position coordinate value of the vehicle calculated from the GPS information using the sense information when the vehicle is determined to be positioned within the at least one area.

2. The mobile terminal of claim 1, wherein the determination unit determines whether the vehicle is positioned within the shadow area using Dilution of Precision (DOP) information included in the GPS information.

3. The mobile terminal of claim 2, wherein the determination unit determines that the vehicle is positioned within the shadow area when Positioning DOP (PDOP) is equal to or greater than a first threshold value and Horizontal DOP (HDOP) is equal to or greater than a second threshold value, the PDOP and the HDOP being included in the DOP information.

4. The mobile terminal of claim 1, wherein the determination unit determines whether the vehicle is positioned within the multi-path area, using an error between positions of the vehicle which are calculated using the GPS information and the sense information, respectively.

5. The mobile terminal of claim 4, wherein the determination unit determines that the vehicle is positioned within the multi-path area when an error between a position of the vehicle calculated using the GPS information and a position of the vehicle calculated using the sensing information is equal to or greater than a certain value for each road grade.

6. The mobile terminal of claims 1, further comprising a matching unit configured to match as a current position of the vehicle the corrected current position coordinate value of the vehicle to map data previously stored in the mobile terminal.

7. A method of correcting, by a mobile terminal, a position error of a vehicle, the method comprising:
receiving GPS information from a GPS satellite;
acquiring sensing information from at least one of a speed sensor and a steering sensor of a vehicle connected through an external interface;
determining whether the vehicle is positioned within at least one of a shadow area and a multi-path area using at least one of the GPS information and the sensing information;
correcting a current position coordinate value of the vehicle calculated from the GPS information using the sense information when the vehicle is determined to be positioned within the at least one area; and
matching as a current position of the vehicle the corrected current position coordinate value of the vehicle to map data previously stored in the mobile terminal.

8. The method of claim 7, wherein the determining comprises determining whether the vehicle is positioned within the shadow area using Dilution of Precision (DOP) information included in the GPS information.

9. The method of claim 8, wherein the determining comprises determining that the vehicle is positioned within the shadow area when Positioning DOP (PDOP) is equal to or greater than a first threshold value and Horizontal DOP (HDOP) is equal to or greater than a second threshold value, the PDOP and the HDOP being included in the DOP information.

10. The method of claim 7, wherein the determining comprises determining whether the vehicle is positioned within the multi-path area, using an error between positions of the vehicle which are calculated using the GPS information and the sense information, respectively.

11. The method of claim 10, wherein the determining comprises determining that the vehicle is positioned within the multi-path area when an error between a position of the vehicle calculated using the GPS information and a position of the vehicle calculated using the sensing information is equal to or greater than a certain value for each road grade.
